(19) United States
(12) Patent Application Publication
(10) Pub. No.: US 2026/0349517 A1
(43) Pub. Date: Nov. 5, 2026

(54) HAPTIC SIGNAL PROCESSING METHOD AND DEVICE FOR PERFORMING SAME

(71) Applicant: LG ELECTRONICS INC., Seoul (KR)

(72) Inventors: Dongsung SHIN, Seoul (KR); Minwoo KIM, Seoul (KR); Youngwook KIM, Seoul (KR); Daesung KIM, Seoul (KR); Sangik MUN, Seoul (KR)

(73) Assignee: LG ELECTRONICS INC., Seoul (KR)

(21) Appl. No.: 19/487,892

(22) PCT Filed: Jul. 3, 2023
(86) PCT No.: PCT/KR2023/009283

§ 371 Date: Nov. 25, 2025

(51) Int. Cl. G06F 3/01; G06F 3/16

(52) U.S. Cl. CPC G06F 3/016; G06F 3/16

(57) ABSTRACT

The present disclosure relates to a haptic signal processing method and a device for performing same, wherein even when a host device and a client device are interconnected through a legacy communication protocol having only an audio transmission path, a haptic signal is provided from the host device to the client device through the audio transmission path so that the haptic signal can be outputted from the client device. According to the present disclosure, a haptic signal processing method may be provided, the method comprising the steps of: obtaining haptic information about an average energy for each section of a first haptic signal and a signal magnitude of each of N representative low frequencies; arranging the haptic information in a high frequency band of the first haptic signal; generating a mixed signal by mixing the first haptic signal, in which the haptic information is arranged in the high frequency band, with a first audio signal; and transmitting the mixed signal through the audio transmission path.

### TECHNICAL FIELD

The present disclosure relates to a haptic signal processing method for transmitting, receiving, and outputting a haptic signal, and an apparatus for performing the same.

### BACKGROUND

Haptic technology has been widely applied to various multimedia contents such as games, movies, and music. Systems supporting haptic feedback are already in widespread use through various products, including vibration earphones and headphones, home theater systems, four-dimensional (4D) cinemas, immersive game consoles, smartphones, tablets, and wearable devices. Haptic-enabled products provide an environment that allows users to experience and immerse themselves in multimedia content in a more realistic manner.

As a client device (or slave device), many portable controllers that are connected to a host device (or master device) such as a game console through a wired or wireless connection have been introduced not only to provide haptic feedback to a user but also to receive a user command and deliver the user command to the host device. Examples of the host device may include a game console, and examples of the client device or the portable controller may include a dedicated wired or wireless game controller or a smartphone.

The host device may transmit a haptic signal and an audio signal to the client device. In this case, when each of the haptic signal and the audio signal is a stereo signal, a 2-channel stereo transmission path for the haptic signal and a 2-channel stereo transmission path for the audio signal, that is, a four-channel transmission path, may be required. Alternatively, when each of the haptic signal and the audio signal is a mono signal, a one-channel mono transmission path for the haptic signal and a one-channel mono transmission path for the audio signal, that is, a two-channel transmission path, may be required.

However, when the host device and the client device are interconnected through a legacy communication protocol in which only an audio transmission path exists and no separate haptic signal transmission path is provided, there is a problem in that it is difficult for the haptic signal to be transmitted from the host device to the client device.

### DISCLOSURE

### Technical Problem

The present disclosure aims to provide a haptic signal processing method and an apparatus for performing the same, which enable a haptic signal to be transmitted from a host device to a client device through an audio transmission path and to be output by the client device, even when the host device and the client device are interconnected through a legacy communication protocol having only the audio transmission path.

### Technical Solution

In an aspect of the present disclosure, provided herein is a haptic signal processing method. The haptic signal processing method includes: acquiring haptic information on an average energy for each section of a first haptic signal and signal magnitudes of N representative low frequencies; placing the haptic information in a high-frequency band of the first haptic signal; generating a mixed signal by mixing the first haptic signal, in which the haptic information is placed in the high-frequency band, with a first audio signal; and transmitting the mixed signal through an audio transmission path.

The high-frequency band may be an inaudible band.

The haptic signal processing method may include: buffering the first haptic signal for a first predetermined time length; performing a window function process on the buffered haptic signal while overlapping the buffered haptic signal by a second predetermined time length than the first predetermined time length; and calculating an average energy of the windowed haptic signal.

The haptic signal processing method may further include converting the windowed haptic signal into a frequency-domain haptic signal, and the haptic information may be placed in the high-frequency band of the frequency-domain haptic signal.

The haptic signal processing method may further include converting the frequency-domain haptic information including the haptic information into a time-domain haptic signal, and the time-domain haptic signal may be mixed with the first audio signal.

The audio transmission path may be a two-channel stereo signal transmission path.

The average energy and N representative frequency signals may be respectively converted into N+1 high-frequency signals of the high-frequency band and placed in the high-frequency band.

The haptic signal processing method may further include: receiving the mixed signal; extracting the haptic information from the received mixed signal; synthesizing a second haptic signal based on the haptic information; and outputting the second haptic signal.

The second haptic signal may be synthesized from the haptic information based on wave characteristics for each of the N representative low frequencies.

The haptic signal processing method may further include: performing low-frequency bandpass filtering on the received mixed signal to extract a second audio signal from the received mixed signal; and outputting the second audio signal.

In another aspect of the present disclosure, provided herein is a host device. The host device includes: a communication unit configured to communicate with a client device; a memory configured to store multimedia content; and a processor configured to: execute the multimedia content to generate a first haptic signal and a first audio signal; acquire haptic information on an average energy for each section of a first haptic signal and signal magnitudes of N representative low frequencies; place the haptic information in a high-frequency band of the first haptic signal; generate a mixed signal by mixing the first haptic signal, in which the haptic information is placed in the high-frequency band, with a first audio signal; and transmit the mixed signal through an audio transmission path to the client device.

In a further aspect of the present disclosure, provided herein is a client device. The client device includes: a haptic module; a communication unit configured to communicate with a host device; and a processor configured to: receive a mixed signal through an audio transmission path with the host device; extract haptic information on an average energy for each section of a first haptic signal and signal magnitudes of N representative low frequencies from the received mixed signal; synthesize a second haptic signal based on the haptic information; and output the second haptic signal through the haptic module.

### Advantageous Effects

A haptic signal processing method and an apparatus for performing the same according to the present disclosure have the following effects.

According to at least one aspect of the present disclosure, even when a host device and a client device are interconnected through a legacy communication protocol having only an audio transmission path, a haptic signal may be transmitted from the host device to the client device through the audio transmission path, thereby providing an advantage that the haptic signal may be output by the client device.

The effects obtainable from the present disclosure are not limited to the effects described above, and other effects not mentioned herein will be clearly understood by those skilled in the art to which the present disclosure pertains from the following description.

### BRIEF DESCRIPTION OF THE DRAWINGS

FIG. 1 illustrates a system capable of transmitting and receiving a haptic signal according to one aspect of the present disclosure.

FIG. 2 is a block diagram of the system of FIG. 1.

FIG. 3 illustrates a modified example of the system of FIG. 1.

FIGS. 4 and 5 illustrate examples of a frequency band of a tactile effect capable of being output by a client device according to one aspect of the present disclosure.

FIG. 6 illustrates transmission of an audio signal and a haptic signal between a host device and a client device according to related art.

FIG. 7 illustrates transmission of an audio signal and a haptic signal between a host device and a client device according to one aspect of the present disclosure.

FIG. 8 is a flowchart illustrating operations of the host device of FIG. 7.

FIG. 9 is graphs of an audio signal and a haptic signal processed by the host device of FIG. 7.

FIG. 10 is a flowchart illustrating operations of the client device of FIG. 7.

FIG. 11 is a graph illustrating wave characteristics for each representative frequency.

FIG. 12 is graphs of an audio signal and a haptic signal processed by the client device of FIG. 7.

### DETAILED DESCRIPTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

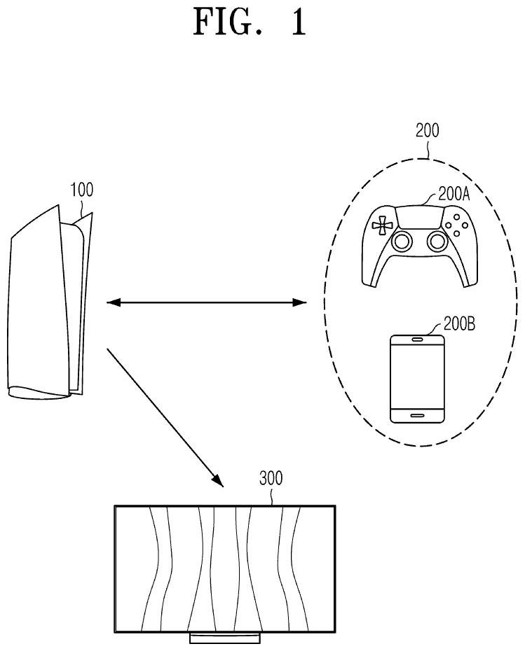

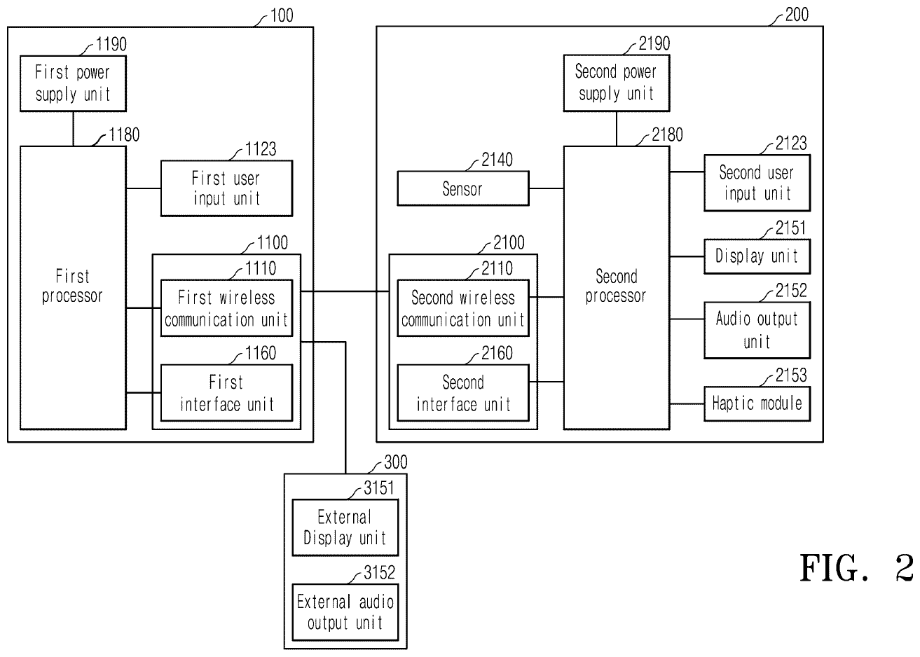

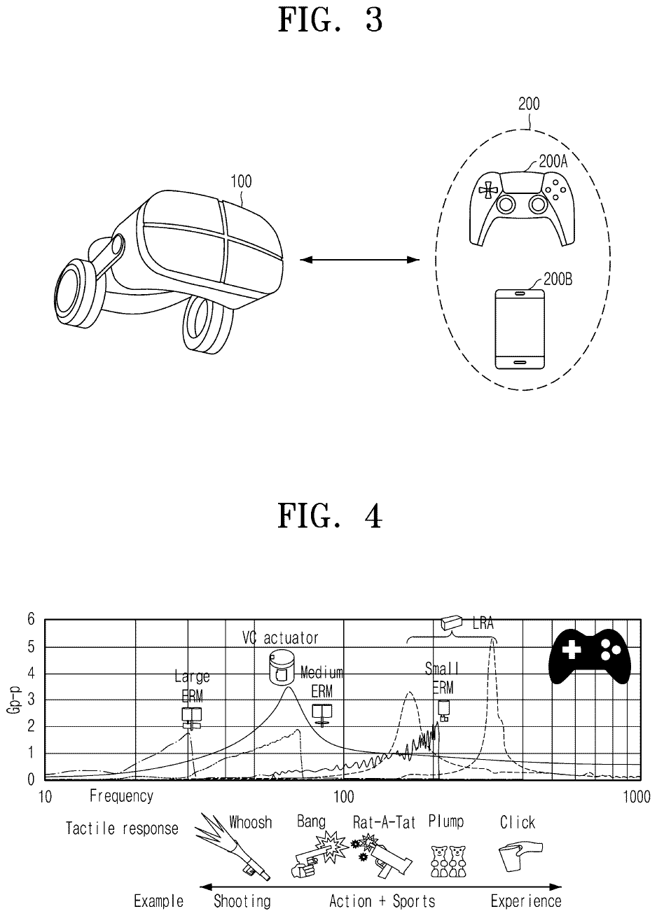

Hereinafter, a system for transmitting and receiving a haptic signal will be described with reference to FIGS. 1 to 3. FIGS. 1 and 3 illustrate a system for transmitting and receiving a haptic signal. FIG. 2 is a block diagram of the system shown in FIG. 1. FIG. 3 illustrates a modified example of the system shown in FIG. 1.

As illustrated in FIG. 1, a system for transmitting and receiving a haptic signal includes a host device 100 configured to generate a haptic signal and a client device 200 connected to the host device 100 through a wired or wireless connection and configured to receive and output the generated haptic signal. The system may further include an external multimedia device 300 connected to the host device 100 through a wired or wireless connection and configured to receive and output at least one of a video signal and an audio signal generated by the host device 100. To this end, the external multimedia device 300 may include at least one of an external display 3151 and an external audio output unit 3152.

In FIG. 1, the host device 100 is exemplified as a game console, the client device 200 is exemplified as a terminal such as a wireless game controller 200A or a smartphone 200B, and the external multimedia device 300 is exemplified as a television (TV). However, the present disclosure is not limited thereto.

Hereinafter, the system will be described in more detail with reference to FIG. 2.

First, the host device 100 will be described. The host device 100 may include a first wireless communication unit 1110, a first user input unit 1123, a first interface unit 1160, a first processor 1180, and a first power supply unit 1190. The host device 100 may include more or fewer components than those listed above.

Each of the components will be described in detail below.

The first wireless communication unit 1110 allows the host device 100 to communicate with the client device 200 or the external multimedia device 300. The first wireless communication unit 1110 may include at least one of a wireless Internet module and a short-range communication module.

The wireless Internet module refers to a module for wireless Internet access, which may be built in or externally attached to the host device 100. The wireless Internet module is configured to transmit and receive wireless signals over a communication network according to wireless Internet technologies.

Wireless Internet technologies include, for example, Wireless LAN (WLAN), Wireless-Fidelity (Wi-Fi), Wireless Fidelity (Wi-Fi) Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), Long Term Evolution-Advanced (LTE-A), and 5G, wherein the wireless Internet module transmits and receives data in accordance with at least one wireless Internet technology, including Internet technologies not listed above.

The short range communication module is for short range communication, and may support short range communication using at least one of Bluetooth™, Radio Frequency Identification (RFID), Infrared Data Association (IrDA), Ultra-Wideband (UWB), ZigBee, Near Field communication (NFC), Wireless-Fidelity (Wi-Fi), Wi-Fi Direct, and Wireless Universal Serial Bus (Wireless USB) technologies.

The short-range communication module may detect (or recognize) the client device 200 capable of communicating with the host device 100 in the vicinity of the host device 100. In addition, when the detected client device 200 is an authenticated device capable of communicating with the host device 100 according to the present disclosure, the first processor 1180 may transmit at least a part of data processed by the host device 100 to the client device 200 through the short-range communication module. Accordingly, the client device 200 may utilize the data processed by the host device 100. Furthermore, at least a part of data processed by the client device 200 may be received by the host device 100 through the short-range communication module. Accordingly, the host device 100 may utilize the data processed by the client device 200.

In the foregoing description, the host device 100 has been described as communicating with the client device 200 or the external multimedia device 300 through the first wireless communication unit 1110. However, the host device 100 may also communicate with the client device 200 or the external multimedia device 300 through the first interface unit 1160.

The first user input unit 1123 is configured to receive information from a user. When information or a user command is input through the first user input unit 1123, the first processor 1180 may control an operation of the host device 100 to correspond to the input information or user command. The first user input unit 1123 may include at least one of a mechanical input means and a touch input means.

The first interface unit 1160 serves as a communication path between the host device 100 and an external device (for example, the client device 200 and/or the external multimedia device 300) connected to the host device 100. The interface unit 1160 enables data to be received from the external device or data in the host device 100 to be transmitted to the external device. For example, wired/wireless data ports, audio input/output (I/O) ports, video I/O ports, and universal serial bus (USB) ports may be included in the first interface unit 1160.

The first wireless communication unit 1110 and the first interface unit 1160 may be collectively referred to as a first communication unit 1100.

The first processor 1180 controls overall operations of the host device 100. The first processor 1180 may process signals, data, and information input or output through the components described above, or may provide or process appropriate information or functions for a user by executing an application program stored in a memory of the host device 100.

The first processor 1180 may control at least some of the components to execute the application program stored in the memory. Furthermore, the first processor 1180 may operate at least two or more components included in the host device 100 in combination with each other to execute the application program.

The memory may be configured to be included in the first processor 1180, or may be configured as a separate component independent of the first processor 1180 within the host device 100.

When the client device 200 is connected to the host device 100, the client device 200 may be recognized by the host device 100. Then, the first processor 1180 may receive an identifier (ID) of the client device 200 from the client device 200 through the first wireless communication unit 1110. The ID of the client device 200 is used to identify a type of the client device 200.

The first processor 1180 may control overall operations of the host device 100 such that the host device 100 operates in accordance with the type of the connected client device 200 based on the ID of the client device 200.

Under the control of the first processor 1180, the first power supply unit 1190 supplies power to each component included in the host device 100 by receiving external or internal power. The first power supply unit 1190 may include a battery, and the battery may be either a built-in battery or a replaceable battery. The first power supply unit 1190 may include a power management integrated circuit (PMIC) for power management of a mobile device.

Hereinafter, the client device 200 will be described.

The client device 200 may include a second wireless communication unit 2110, a second user input unit 2123, a sensor 2140, a display unit 2151, an audio output unit 2152, a haptic module 2153, a second interface unit 2160, a second processor 2180, and a second power supply unit 2190. The client device 200 may include more or fewer components than those listed above. For example, when the client device 200 is configured as a wireless game controller, the client device 200 may not include at least one of the display unit 2151 and the audio output unit 2152. Alternatively, when the client device 200 is configured as a wireless game controller, the client device 200 may not include one of the second wireless communication unit 2110 and the second interface unit 2160.

The second wireless communication unit 2110 allows the client device 200 to communicate with the host device 100, and may include at least one of a wireless Internet module and a short-range communication module. The wireless Internet module and the short-range communication module are configured in the same manner as described above.

In the foregoing description, the client device 200 has been described as communicating with the host device 100 through the second wireless communication unit 2110. However, the client device 200 may also communicate with the host device 100 through the second interface unit 2160.

The second user input unit 2123 is configured to receive information from a user. When information or a user command is input through the second user input unit 2123, the second processor 2180 may control an operation of the client device 200 to correspond to the input information or user command. The second user input unit 2123 may include at least one of a mechanical input means and a touch input means.

The sensor 2140 may include at least one of an acceleration sensor, a magnetic sensor, a gravity sensor (G-sensor), a gyroscope sensor, and a motion sensor. The second processor 2180 may track a real-time movement of the client device 200 on 3 degrees of freedom (3-DoF) or 6 degrees of freedom (6-DoF) through the sensor 2140.

The display unit 2151 may include at least one of a liquid crystal display (LCD), a thin film transistor-liquid crystal display (TFT LCD), an organic light-emitting diode (OLED), a flexible display, a three-dimensional display (3D display), and an e-ink display.

The display unit 2151 may be provided in one or more units depending on an implementation type of the client device 200. When the display unit 2151 is configured with a plurality of displays, the client device 200 may include a plurality of displays that are spaced apart from or integrally arranged on one surface, or a plurality of displays that are respectively disposed on different surfaces.

The display unit 2151 may include a touch sensor configured to detect a touch on the display unit 2151 such that a control command can be input by touch. When the display unit 2151 is touched, the touch sensor may detect the touch, and the second processor 2180 may generate a control command corresponding to the touch based thereon. The touch input may be letters or numbers, instructions in various modes, or assignable menu items.

The touch sensor may be integrally formed with the display. For example, the touch sensor may be disposed on a substrate of the display, or may be provided in the display.

The display unit 2151 may form a touchscreen together with the touch sensor, in which case the touchscreen may function as the second user input unit 2123.

The audio output unit 2152 may output audio data received from the host device 100 through the wireless communication unit 2110 or the interface unit 1160, or audio data stored in a memory of the client device 200. The audio output unit 2152 may also output an audio signal related to a function performed on the client device 200 (e.g., sound effect). The audio output unit 2152 may include a receiver, a speaker, or a buzzer.

The haptic module 2153 generates various tactile effects that may be felt by the user. A representative example of the tactile effect generated by the haptic module 2153 may be vibration. The intensity and pattern of vibration generated by the haptic module 2153 may be controlled by user selection or settings of the second processor 2180. For example, the haptic module 2153 may synthesize and output different vibrations or sequentially output the same. Accordingly, the haptic module 2153 may also be referred to as a haptic output unit.

The haptic module 2153 may generate various tactile effects including not only vibration but also effects caused by stimuli such as an array of pins vertically moving relative to a contact skin surface, air blowing or suction through a nozzle or an intake port, brushing against a skin surface, contact of an electrode, or electrostatic force, and effects caused by reproducing cold and warm sensations using an element capable of absorbing or generating heat.

The haptic module 2153 may not only deliver a tactile effect through direct contact but also be implemented such that a user is capable of perceiving the tactile effect through proprioceptive sensations of a finger, an arm, or the like. The haptic module 2153 may be provided with at least one actuator to output various vibrations depending on the configuration of the client device 200.

The second interface unit 2160 serves as a communication path between the client device 200 and an external device (for example, the host device 100 or a wired or wireless headset for audio output, not shown) connected to the client device 200. The second interface unit 2160 enables data to be received from the external device or data in the client device 200 to be transmitted to the external device. For example, wired/wireless data ports, audio I/O ports, video I/O ports, and USB ports may be included in the second interface unit 2160.

The second wireless communication unit 2110 and the second interface unit 2160 may be collectively referred to as a second communication unit 2100.

The second processor 2180 controls overall operations of the client device 200. The second processor 2180 may process signals, data, and information input or output through the components described above, or may provide or process appropriate information or functions for a user by executing an application program stored in the memory of the client device 200.

The second processor 2180 may control at least some of the components to execute the application program stored in the memory. Furthermore, the second processor 2180 may operate at least two or more components included in the client device 200 in combination with each other to execute the application program.

The memory may be configured to be included in the second processor 2180, or may be configured as a separate component independent of the second processor 2180 within the client device 200.

Under the control of the second processor 2180, the second power supply unit 2190 supplies power to each component included in the client device 200 by receiving external or internal power. The second power supply unit 2190 may include a battery, and the battery may be either a built-in battery or a replaceable battery. The second power supply unit 2190 may include a PMIC for power management of a mobile device.

In the foregoing description, the host device 100 has been described as being separately and independently connected to the external multimedia device 300 through a wired or wireless connection. However, the present disclosure is not limited thereto. The host device 100 may be configured as a single device including the external multimedia device 300. For example, as illustrated in FIG. 3, the host device 100 may be configured as a wearable device including a display and an audio output unit therein. Examples of the wearable device 100 may include smart glasses and a head-mounted display (HMD).

Hereinafter, a tactile effect (or vibration) capable of being output by the client device 200 according to a haptic signal will be described with reference to FIGS. 4 and 5. FIGS. 4 and 5 illustrate examples of a frequency band of a tactile effect capable of being output by a client device according to one aspect of the present disclosure.

The haptic module 2153 of the client device 200 may include one or more actuators to provide vibration.

In particular, as illustrated in FIG. 4, the haptic module 2153 may include a plurality of actuators having different characteristics such that the client device 200 is capable of providing various types of tactile effects (or vibrations) (i.e., with different vibration frequencies) to a user. Accordingly, the user may experience unique tactile effects corresponding to various activities such as shooting, action, and sports through the client device 200.

Accordingly, as illustrated in FIG. 5, the haptic module 2153 may be configured to provide vibrations in a relatively wide frequency band having a plurality of resonant frequencies, rather than providing vibrations in a narrow frequency band having a single resonant frequency. A haptic signal for generating such wideband vibrations may also be referred to as a haptic audio signal because the frequency band thereof may overlap with the frequency band of an audible audio signal.

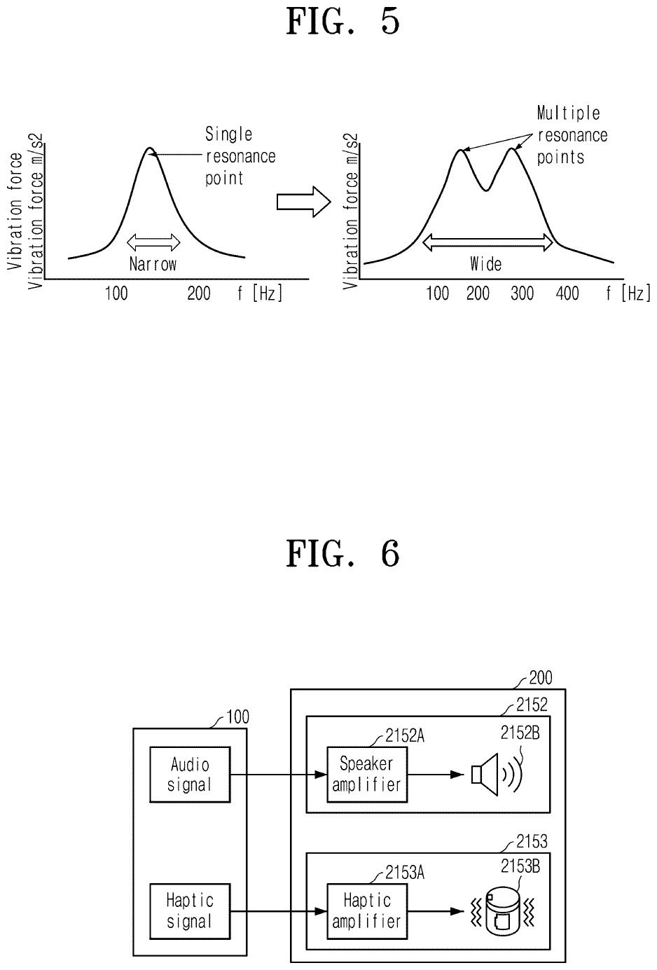

Hereinafter, a transmission path of an audio signal and a haptic signal transmitted from the host device 100 to the client device 200 will be described with reference to FIG. 6. FIG. 6 illustrates transmission of an audio signal and a haptic signal between the host device and the client device according to related art. Here, the term “audio signal” refers to a signal generated or intended to be output through the audio output unit 2152, and the term “haptic signal” refers to a signal generated or intended to be output through the haptic module 2153.

The host device 100 may generate the audio signal and the haptic signal. The host device 100 may generate or reproduce the audio signal and the haptic signal by executing multimedia content stored in the memory thereof or received from another external device.

The audio signal and the haptic signal may be transmitted to and received from the client device 200 through the first communication unit 1100 of the host device 100 and the second communication unit 2100 of the client device 200.

In this case, the audio signal and the haptic signal may be transmitted from the host device 100 to the client device 200 through separate and independent communication paths.

That is, when the audio signal is a mono signal, a one-channel mono audio signal transmission path is required, and when the audio signal is a stereo signal, a two-channel stereo audio signal transmission path is required. The audio signal transmission path may be formed through the first wireless communication unit 1110 and the second wireless communication unit 2110, or may be formed through the first interface unit 1160 and the second interface unit 2160.

Independently of the audio signal transmission path, when the haptic signal is a mono signal, a one-channel mono haptic signal transmission path is further required, and when the haptic signal is a stereo signal, a two-channel stereo haptic signal transmission path is further required. The haptic signal transmission path may be formed through the first wireless communication unit 1110 and the second wireless communication unit 2110, or may be formed through the first interface unit 1160 and the second interface unit 2160.

The audio signal transmitted to the client device 200 may be output through the audio output unit 2152, which includes a speaker amplifier 2152A and a speaker 2152B.

The haptic signal transmitted to the client device 200 may be output through the haptic module 2153, which includes a haptic amplifier 2153A and an actuator 2153B.

However, when the host device 100 and the client device 200 are interconnected through a legacy communication protocol in which only an audio transmission path exists and no separate haptic signal transmission path is provided, there is a problem in that it is difficult for the haptic signal to be transmitted from the host device 100 to the client device 200.

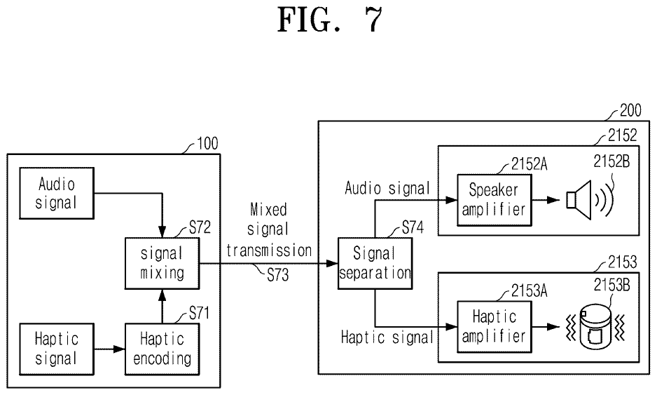

Hereinafter, a case in which not only the audio signal but also the haptic signal is transmitted through the audio signal transmission path between the host device 100 and the client device 200 will be described with reference to FIG. 7. FIG. 7 illustrates transmission of an audio signal and a haptic signal between the host device and the client device according to one aspect of the present disclosure.

The first processor 1180 of the host device 100 may encode the haptic signal [S71].

The first processor 1180 may mix the encoded haptic signal with the audio signal to generate a mixed signal [S72].

The first processor 1180 may control the generated mixed signal to be transmitted to the client device 200 along the audio signal transmission path through the first communication unit 1100 of the host device 100 (that is, through one of the first wireless communication unit 1110 and the first interface unit 1160) [S73].

The second processor 2180 of the client device 200 may control the mixed signal to be received from the host device 100 along the audio signal transmission path through the second communication unit 2100 of the client device 200 (that is, through one of the second wireless communication unit 2110 and the second interface unit 2160) [S73].

The second processor 2180 may separate the mixed signal into an audio signal and a haptic signal [S74].

The second processor 2180 may control the separated audio signal to be output through the audio output unit 2152 of the client device 200 and the separated haptic signal to be output through the haptic module 2153 of the client device 200.

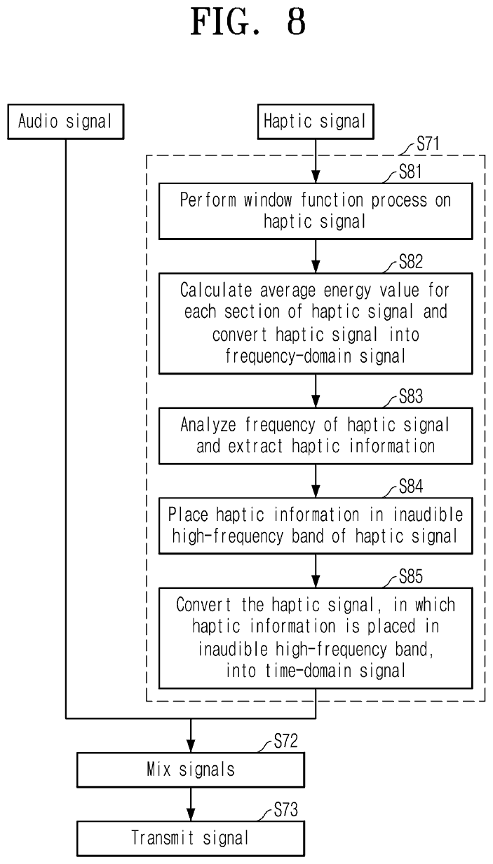

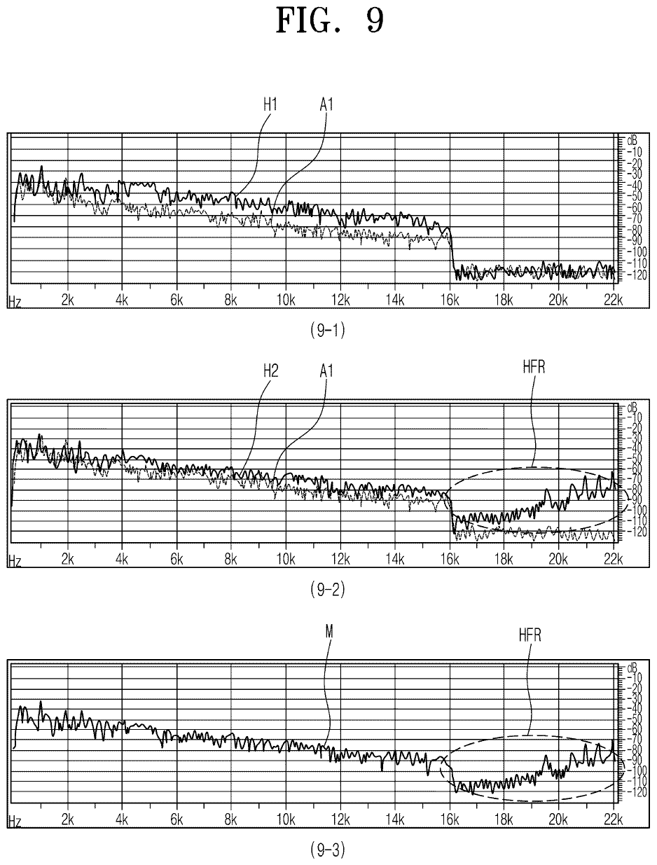

Hereinafter, operations of the host device 100 of FIG. 7 will be described in more detail with reference to FIGS. 8 and 9. FIG. 8 is a flowchart illustrating the operations of the host device of FIG. 7. FIG. 9 is graphs of an audio signal and a haptic signal processed by the host device of FIG. 7.

First, referring to FIG. 8, the first processor 1180 of the host device 100 may store the haptic signal in a buffer for every first predetermined time length (for example, 10 ms). The first processor 1180 may perform a window function process on the stored signals while overlapping the signals by a second predetermined time length (for example, 5 ms) shorter than the first predetermined time length so as to prevent frequency leakage [S81]. Examples of the window function may include a Hamming window or a Hanning window. If frequency leakage does not need to be considered, the stored signals may not be overlapped. Information on the first predetermined time length, the second predetermined time length, and the window function may be preselected according to characteristics of the haptic signal. The information may be shared with the client device 200 in advance at the time of factory shipment or when communication between the host device 100 and the client device 200 is established.

Next, the first processor 1180 may calculate an average energy (AvE) for each section of the haptic signal [S82]. The average energy for each section may be obtained, for example, by performing a root mean square (RMS) operation on each windowed haptic signal. Then, the first processor 1180 may convert each windowed haptic signal into a frequency-domain haptic signal [S82]. The conversion into the frequency-domain haptic signal may be performed, for example, by performing a Fast Fourier Transform (FFT) operation on each windowed haptic signal.

Next, the first processor 1180 may perform frequency analysis on the frequency-domain haptic signal to obtain signal magnitudes (e.g., AF1, AF2, AF3, AF4, and AF5) of N representative low frequencies (e.g., five low frequencies F1, F2, F3, F4, and F5) that have a significant influence on vibration or tactile effects [S83]. The N representative low frequencies (F1, F2, F3, F4, and F5) belonging to a low-frequency band (e.g., below 500 Hz) may be preselected according to the characteristics of the haptic signal. The N representative low frequencies may be shared with the client device 200 in advance as default values at the time of factory shipment, or information thereon may be transmitted to the client device 200 when communication between the host device 100 and the client device 200 is established.

The signal magnitudes (AF1, AF2, AF3, AF4, and AF5) of the representative low frequencies for each section of the haptic signal and the average energy (AvE) may be obtained to reduce the data size of the transmitted signal, and may also be referred to as haptic information of the haptic signal.

Next, the first processor 1180 may reallocate the average energy for each section and the representative low-frequency signals for each section to an inaudible high-frequency band of the haptic signal (e.g., 18 kHz or higher) [S84]. For example, the first processor 1180 may assign the average energy (AvE) for each section and the magnitudes of the representative frequency signals (F1, F2, F3, F4, and F5) for each section to inaudible high-frequency signals. That is, the average energy (AvE) for each section is assigned to one high-frequency signal, and the magnitudes of the N representative low-frequency signals (F1, F2, F3, F4, and F5) may be respectively assigned to N high-frequency signals. That is, the average energy for each section and the magnitudes of the N representative low-frequency signals may be converted into a total of N+1 high-frequency signals. This is merely an example, and it is apparent that the average energy for each section and the representative low-frequency signals for each section may also be reallocated to the inaudible high-frequency band in other ways.

In order for the client device 200, which later receives the N+1 high-frequency signals, to smoothly extract the average energy for each section and the magnitudes of the respective low-frequency signals from the N+1 high-frequency signals, the first processor 1180 may perform scaling of frequencies and signal magnitudes. For example, the first processor 1180 may perform frequency scaling such that a second frequency interval between adjacent high-frequency signals becomes wider than a first frequency interval between adjacent low-frequency signals (F1, F2, F3, F4, and F5). The first processor 1180 may also perform magnitude scaling such that when the average energy (AvE) for each section and the first magnitudes (AF1, AF2, AF3, AF4, and AF5) of the representative low-frequency signals for each section are reallocated to the inaudible high-frequency band, they are converted into second magnitudes smaller than the first magnitudes. The first processor 1180 may also perform magnitude scaling such that, when the average energy (AvE) for each section and the first magnitudes (AF1, AF2, AF3, AF4, and AF5) of the representative low-frequency signals for each section are reallocated to the inaudible high-frequency band, the average energy and the first magnitudes are converted into second magnitudes smaller than the first magnitudes.

The scaling information and the N+1 high-frequency signals may also be preselected according to the characteristics of the haptic signal. The scaling information and information on the N+1 high-frequency signals may be shared with the client device 200 in advance as default values at the time of factory shipment, or may be transmitted to the client device 200 when communication between the host device 100 and the client device 200 is established.

Next, the first processor 1180 may convert the haptic signal, in which the average energy (AvE) for each section and the signal magnitudes (AF1, AF2, AF3, AF4, AF5) of the representative low frequencies are reallocated to the inaudible high-frequency band, into a time-domain signal [S85]. As a result, the encoding step (S71) of the haptic signal mentioned in FIG. 7 may be completed.

The first processor 1180 may mix the encoded haptic signal with the audio signal to generate a mixed signal and transmit the mixed signal to the client device 200 along the audio signal transmission path in a streaming manner [S72 and S73].

Hereinafter, the audio signal and the haptic signal processed by the host device 100 will be described with reference to FIG. 9.

(9-1) of FIG. 9 is a graph in the frequency domain illustrating an audio signal (A1) before step S72 and a haptic signal (H1) before step S71.

(9-2) of FIG. 9 is a graph in the frequency domain illustrating the audio signal (A1) before step S72 and the haptic signal (H2) after step S71. Compared with the graph of (9-1) of FIG. 9, it can be seen that the haptic information is encoded in the inaudible high-frequency region (HFR) of the haptic signal (H2) after step S71.

(9-3) of FIG. 9 is a graph in the frequency domain illustrating a mixed signal (M). It can be seen that the haptic information remains present in the inaudible high-frequency region (HFR) of the mixed signal.

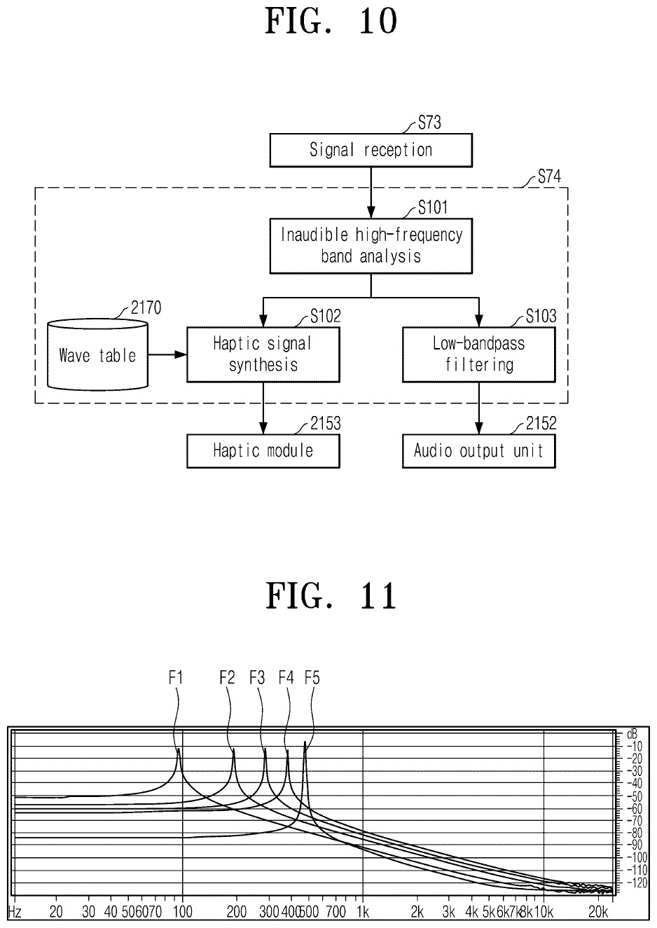

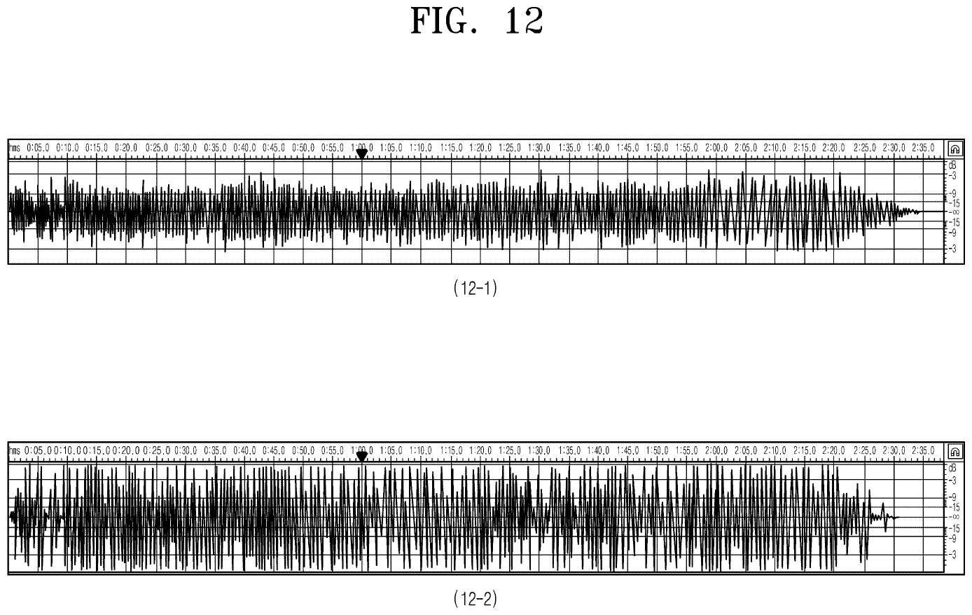

Hereinafter, operations of the client device 200 of FIG. 7 will be described in more detail with reference to FIGS. 10 to 12. FIG. 10 is a flowchart illustrating the operations of the client device of FIG. 7. FIG. 11 is a graph illustrating wave characteristics for each representative frequency. FIG. 12 is graphs of an audio signal and a haptic signal processed by the client device of FIG. 7.

First, referring to FIG. 10, the second processor 2180 of the client device 200 may control the mixed signal to be received in a streaming manner from the host device 100 through the audio signal transmission path [S73].

The second processor 2180 may analyze the inaudible high-frequency band of the mixed signal to extract the haptic information [S101]. For example, the second processor 2180 may obtain a second signal magnitude of each of the N+1 high-frequency signals and perform inverse scaling thereon to obtain the average energy (AvE) for each section and the first signal magnitudes (AF1, AF2, AF3, AF4, AF5) of the N representative low frequencies. This is possible because, as described above, the second processor 2180 has the information on the N low frequencies, the scaling information, and the information on the N+1 high frequencies.

Next, the client device 200 may store a predefined wave table in a memory 2170 thereof. As illustrated in FIG. 11, the wave table may include information on wave characteristics for each of the representative low frequencies (F1, F2, F3, F4, and F5). Accordingly, the second processor 2180 may synthesize a haptic signal based on the wave table, the first signal magnitudes (AF1, AF2, AF3, AF4, and AF5) of the N representative low-frequency signals, and the average energy (AvE) [S102]. In the above description, N is exemplified as five, but N may be greater or smaller than five. The haptic signal may be processed with an inverse window function during synthesis.

The second processor 2180 may control the synthesized haptic signal to be output through the haptic module 2153. The synthesized haptic signal is re-synthesized so as to become closer to the original haptic signal (that is, the original haptic signal generated by the host device 100), thereby allowing a user to experience substantially the same vibration or tactile effects. Hereinafter, to distinguish between the original haptic signal and the synthesized haptic signal, the original haptic signal and the synthesized haptic signal may be referred to as a first haptic signal and a second haptic signal, respectively.

The second processor 2180 may perform low-frequency bandpass filtering on the mixed signal to extract the audio signal from the mixed signal [S103].

The second processor 2180 may control the low-frequency band-passed signal to be output as an audio signal through the audio output unit 2152. Since the haptic signal is mixed in the mixed signal, a portion of the haptic signal that passes through the low-frequency band may also be output together with the audio signal through the audio output unit 2152. The audio signal may include a sound effect corresponding to the low-frequency band-passed haptic signal, and the portion of the haptic signal that passes through the low-frequency band may enhance the realism of the sound effect perceived by the user.

Hereinafter, the audio signal and the haptic signal output by the client device 200 will be described with reference to FIG. 12.

(12-1) of FIG. 12 illustrates an example of the low-band-passed mixed signal in the time domain, which is output through the audio output unit 2152.

(12-2) of FIG. 12) illustrates an example of the synthesized haptic signal in the time domain, which is output through the haptic module 2153.

Various embodiments may be implemented using a machine-readable medium having instructions stored thereon for execution by a processor to perform various methods presented herein. Examples of possible machine-readable mediums include HDD (Hard Disk Drive), SSD (Solid State Disk), SDD (Silicon Disk Drive), ROM, RAM, CD-ROM, a magnetic tape, a floppy disk, an optical data storage device, the other types of storage mediums presented herein, and combinations thereof. If desired, the machine-readable medium may be realized in the form of a carrier wave (for example, a transmission over the Internet). The foregoing embodiments are merely exemplary and are not to be considered as limiting the present disclosure. The present teachings can be readily applied to other types of methods and apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

1. A haptic signal processing method comprising:
acquiring haptic information on an average energy for each section of a first haptic signal and signal magnitudes of N representative low frequencies;
placing the haptic information in a high-frequency band of the first haptic signal;
generating a mixed signal by mixing the first haptic signal, in which the haptic information is placed in the high-frequency band, with a first audio signal; and
transmitting the mixed signal through an audio transmission path.

2. The method of claim 1, wherein the high-frequency band is an inaudible band.

3. The method of claim 1, comprising:
buffering the first haptic signal for a first predetermined time length;
performing a window function process on the buffered haptic signal while overlapping the buffered haptic signal by a second predetermined time length shorter than the first predetermined time length; and
calculating an average energy of the windowed haptic signal.

4. The method of claim 3, further comprising converting the windowed haptic signal into a frequency-domain haptic signal,
wherein the haptic information is placed in the high-frequency band of the frequency-domain haptic signal.

5. The method of claim 4, further comprising converting the frequency-domain haptic signal including the haptic information into a time-domain haptic signal,
wherein the time-domain haptic signal is mixed with the first audio signal.

6. The method of claim 1, wherein the audio transmission path is a two-channel stereo signal transmission path,

7. The method of claim 1, wherein the average energy and N representative frequency signals are respectively converted into N+1 high-frequency signals of the high-frequency band and placed in the high-frequency band.

8. The method of claim 5, further comprising:
receiving the mixed signal;
extracting the haptic information from the received mixed signal;
synthesizing a second haptic signal based on the haptic information, and
outputting the second haptic signal.

9. The method of claim 8, wherein the second haptic signal is synthesized from the haptic information based on wave characteristics for each of the N representative low frequencies.

10. The method of claim 8, comprising:
performing low-frequency bandpass filtering on the received mixed signal to extract a second audio signal from the received mixed signal; and
outputting the second audio signal.

11. A host device comprising:
a communication unit configured to communicate with a client device;
a memory configured to store multimedia content; and
a processor configured to:
execute the multimedia content to generate a first haptic signal and a first audio signal;
acquire haptic information on an average energy for each section of a first haptic signal and signal magnitudes of N representative low frequencies;
place the haptic information in a high-frequency band of the first haptic signal;
generate a mixed signal by mixing the first haptic signal, in which the haptic information is placed in the high-frequency band, with a first audio signal; and
transmit the mixed signal through an audio transmission path to the client device.

12. The host device of claim 11, wherein the high-frequency band is an inaudible band.

13. The host device of claim 11, wherein the processor is configured to:
buffer the first haptic signal for a first predetermined time length;
perform a window function process on the buffered haptic signal while overlapping the buffered haptic signal by a second predetermined time length shorter than the first predetermined time length; and
calculate an average energy of the windowed haptic signal.

14. The host device of claim 13, wherein the processor is configured to convert the windowed haptic signal into a frequency-domain haptic signal, and
wherein the haptic information is placed in the high-frequency band of the frequency-domain haptic signal.

15. The host device of claim 14, wherein the processor is configured to convert the frequency-domain haptic signal including the haptic information into a time-domain haptic signal, and
wherein the time-domain haptic signal is mixed with the first audio signal.

16. The host device of claim 11, wherein the audio transmission path is a two-channel stereo signal transmission path.

17. The host device of claim 11, wherein the average energy and N representative frequency signals are respectively converted into N+1 high-frequency signals of the high-frequency band and placed in the high-frequency band.

18. A client device comprising:
a haptic module;
a communication unit configured to communicate with a host device; and
a processor configured to:
receive a mixed signal through an audio transmission path with the host device;
extract haptic information on an average energy for each section of a first haptic signal and signal magnitudes of N representative low frequencies from the received mixed signal;
synthesize a second haptic signal based on the haptic information; and
output the second haptic signal through the haptic module.

19. The client device of claim 18, wherein the processor is configured to synthesize a second haptic signal from the haptic information based on wave characteristics for each of the N representative low frequencies.

20. The client device of claim 18, further comprising an audio output unit,
wherein the processor is configured to:
perform low-frequency bandpass filtering on the received mixed signal to extract a second audio signal from the received mixed signal, and
output the second audio signal through the audio output unit.
